(19) United States
(12) Patent Application Publication
(10) Pub. No.: US 2026/0357984 A1
(43) Pub. Date: Nov. 12, 2026

(54) CERAMIC RESISTANCE IGNITER AND METHOD OF MANUFACTURE

(71) Applicant: CoorsTek, Inc., Golden, CO (US)

(72) Inventor: Corey Bergeron, Milford, NH (US)

(21) Appl. No.: 19/667,725

(22) Filed: May 5, 2026

Related U.S. Application Data
(60) Provisional application No. 63/800,642, filed on May 6, 2025.

(51) Int. Cl. F23Q 7/22; C04B 41/45; C04B 41/51; C04B 41/88

(52) U.S. Cl. CPC F23Q 7/22; C04B 41/4523; C04B 41/51; C04B 41/88

(57) ABSTRACT

A ceramic resistance igniter can include a ceramic body. The ceramic body can include a terminal having a metallized coating applied to a portion of a surface thereof and a resistive element extending from the terminal. The resistive element can generate thermal energy when an electrical current is applied. A wire can be coupled to the metallized coating of the terminal to form an electrical connection therewith. A method of manufacturing the ceramic resistance igniter can include providing the ceramic resistance igniter, preparing a surface of the terminal, applying the metallized coating to the terminal, preparing the metallized surface, preheating the ceramic resistance igniter, and coupling the wire to the metallized coating. A method of operating the ceramic resistance igniter can include applying an electrical current through the wire to generate a thermal response in the resistive element and igniting a flammable gas.

### CROSS-REFERENCE TO RELATED APPLICATIONS

This application claims the benefit of U.S. Provisional Application No. 63/800,642, filed on May. 6, 2025. The entire disclosure of the above application is incorporated herein by reference.

### FIELD

The present technology relates to an igniter for a fuel burning device, and, more particularly, to a ceramic resistance igniter and method of manufacture.

### INTRODUCTION

This section provides background information related to the present disclosure which is not necessarily prior art.

A ceramic resistance igniter is a type of non-pilot igniter used in a range of industrial, commercial, and residential applications. In an industrial setting, a ceramic resistance igniter can be found in a furnace, a kiln, or a boiler, where it can provide ignition for a high-temperature heating process. In a commercial application, a ceramic resistance igniter can be used in an HVAC system to provide ignition for a gas heating system, or a commercial oven or dryer. In a residential application, a ceramic resistance igniter can be employed in a gas stove, a water heater, or a pool heater, among other appliances.

Ceramic resistance igniters operate by receiving an electrical current that causes the igniter to rapidly heat to a temperature sufficient to ignite a flammable gas or air-fuel mixture. The igniter can reach a temperature of between 1000 and 1400 degrees Celsius during normal operation. A reliable and consistent electrical connection to the ceramic resistance igniter is necessary for the igniter to heat to the required temperature within an acceptable response time. A variation in the electrical connection can result in inconsistent performance, delayed ignition, or failure of the igniter to operate.

The manufacture of a ceramic resistance igniter can include a multi-step process where a silicon carbide element is formed by casting a ceramic slurry into a mold, followed by firing at high temperatures to produce a recrystallized ceramic body. The fired ceramic body can be subjected to a series of machining and finishing operations to produce a final igniter shape. These operations can include slicing, slotting, and surface preparation, each of which can introduce dimensional variability and an opportunity for a defect.

Manufacturing of certain ceramic resistance igniters can include the formation of a slot or other feature in a terminal end of the ceramic body to receive a mechanical connector. The mechanical connector, which can include a nickel-chromium alloy connector, can be inserted into the slot and secured in place by a metallization process. The metallization process can include the application of a metallic coating to the terminal end of the ceramic body, which can serve to secure the connector in place and provide an electrically conductive interface between the ceramic body and the connector. The connector can then receive a wire lead, which can be crimped or otherwise mechanically attached to the connector to complete the electrical circuit.

The slot-cutting process used to form a slot in the terminal end of the ceramic body can present certain manufacturing challenges. Slot-cutting equipment can produce a slot having a trapezoidal or parallelogram-shaped cross-section rather than an intended rectangular cross-section, due to wear and imprecision in the cutting equipment. A dimensional variation of this type can result in a poor fit between the slot and the mechanical connector, which can require manual rework to ensure proper assembly. The manual rework process can increase a labor cost, reduce production efficiency, and introduce an additional opportunity for handling damage to the ceramic body.

The metallization process can introduce additional manufacturing challenges. The application of a metallic coating by a thermal spray process can cause the mechanical connector to shift or rotate within the slot, resulting in a misalignment of the connector relative to the ceramic body. A misaligned connector can result in a poor electrical connection between the ceramic body and the connector, which can cause inconsistent electrical performance of the igniter. The metallization process can also produce a variation in coating thickness and adhesion, which can further contribute to inconsistent electrical performance and a reduced product yield.

The multi-component connection assembly used in ceramic resistance igniter manufacture can further introduce potential failure points into the electrical circuit. The connection between the ceramic body and the metallized coating, the connection between the metallized coating and the mechanical connector, and the connection between the mechanical connector and the wire lead can each represent an opportunity for electrical resistance, poor contact, or mechanical failure. Reliance on multiple components and multiple assembly steps can result in significant part-to-part variation in electrical performance that can be difficult to predict or control. Complexity of the assembly process can also require a highly skilled operator and specialized equipment, which can increase manufacturing cost and limit production throughput.

Handling of a ceramic resistance igniter during the manufacturing process can present additional challenges due to the nature of the ceramic body. Certain ceramic body designs and shapes can be susceptible to cracking or breakage from mechanical force, oil contamination from handling, and thermal shock during processing. Each additional handling step can increase the risk of damage to the ceramic body, which can result in an increased scrap rate and a reduced manufacturing yield. Sensitivity of the ceramic body to handling damage can also limit the degree to which the manufacturing process can be automated, requiring manual intervention at multiple stages of production.

Accordingly, there is a continuing need for a ceramic resistance igniter and a method of manufacturing a ceramic resistance igniter that can address the foregoing challenges. Desirably, such a ceramic resistance igniter and a method of manufacture can provide a more reliable and consistent electrical connection between a wire and a ceramic body, can reduce the number of components and assembly steps required to manufacture the igniter, can minimize part-to-part variation in electrical performance, can reduce the risk of handling damage to the ceramic body, and can improve manufacturing efficiency and yield.

### SUMMARY

In concordance with the instant disclosure, a ceramic resistance igniter and a method of manufacturing a ceramic resistance igniter that can provide a more reliable and consistent electrical connection between a wire and a ceramic body, can reduce the number of components and assembly steps required to manufacture the igniter, can minimize part-to-part variation in electrical performance, can reduce the risk of handling damage to the ceramic body, and can improve manufacturing efficiency and yield, has surprisingly been discovered. The present technology includes articles of manufacture, systems, and processes that relate to a ceramic resistance igniter and a method of manufacturing a ceramic resistance igniter.

In certain embodiments, a ceramic resistance igniter is provided that can include a ceramic body. The ceramic body can include a terminal and a resistive element. The terminal can include a metallized coating applied to a portion of a surface thereof. The resistive element can extend from the terminal and can be electrically coupled to the terminal. The resistive element can generate thermal energy when an electrical current is applied. A wire can be coupled to the metallized coating of the terminal to form an electrical connection therewith.

In certain embodiments, a method of manufacturing a ceramic resistance igniter is provided that can include preparing a surface of a terminal of a ceramic body. The method can include applying a metallized coating to a portion of the surface of the terminal. The method can include preparing the metallized surface of the terminal. The method can include preheating the ceramic resistance igniter. The method can include coupling a wire to the metallized coating of the terminal to form an electrical connection therewith.

In certain embodiments, a method of operating a ceramic resistance igniter to ignite a flammable gas is provided that can include providing a ceramic resistance igniter, including a ceramic resistance igniter as described herein. The method can include applying an electrical current to the ceramic resistance igniter through the wire. The electrical current can generate a thermal response in the resistive element. The method can include igniting the flammable gas.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a top perspective view of a ceramic resistance igniter, according to an embodiment of the present disclosure;

FIG. 2 is a top perspective view of a green ceramic body, according to an embodiment of the present disclosure;

FIG. 3 is a top perspective view of a ceramic body including a metalized coating, according to an embodiment of the present disclosure;

FIG. 4 is a top perspective view of a ceramic body during a wire coupling process to form a ceramic resistance igniter, according to an embodiment of the present disclosure;

FIG. 5 is a top perspective view of a ceramic body during a wire coupling process to form a ceramic resistance igniter, according to an embodiment of the present disclosure;

FIG. 6 provides a flowchart illustrating a method of manufacturing a ceramic resistance igniter, according to an embodiment of the present disclosure; and

FIG. 7 provides a flowchart illustrating a method of operating a ceramic resistance igniter to ignite a flammable gas, according to an embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1–10, or 2–9, or 3–8, it is also envisioned that Parameter X may have other ranges of values including 1–9, 1–8, 1–3, 1–2, 2–10, 2–8, 2–3, 3–10, 3–9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature’s relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

A ceramic resistance igniter can include a ceramic body having a terminal and a resistive element. The terminal can include a metallized coating applied to a portion of a surface thereof. The resistive element can extend from the terminal and can be electrically coupled to the terminal. The resistive element can generate thermal energy when an electrical current is applied thereto. A wire can be coupled to the metallized coating of the terminal to form an electrical connection therewith. The wire can be coupled to the metallized coating by a laser weld. The laser weld can be formed by a laser such as a fiber laser, an Nd:YAG laser, a direct diode pumped laser, an end-pumped laser, and combinations thereof. The laser welding process can include using an inert shielding gas and can include using a laser power from 50 watts to 150 watts and a focused beam spot size from 0.2 millimeters to 0.4 millimeters thereby reducing thermal shock to the ceramic resistance igniter. The ceramic resistance igniter can provide a more reliable and consistent electrical connection between the wire and the ceramic body. The laser welded connection can eliminate the need for a mechanical connector between the wire and the ceramic body, which can reduce the number of components and assembly steps required to manufacture the igniter. The elimination of the mechanical connector can reduce part-to-part variation in electrical performance and can reduce the risk of handling damage to the ceramic body during manufacturing. The ceramic resistance igniter can provide improved manufacturing efficiency and yield while maintaining the ability to reach a temperature sufficient to ignite a flammable gas when an electrical current is applied thereto.

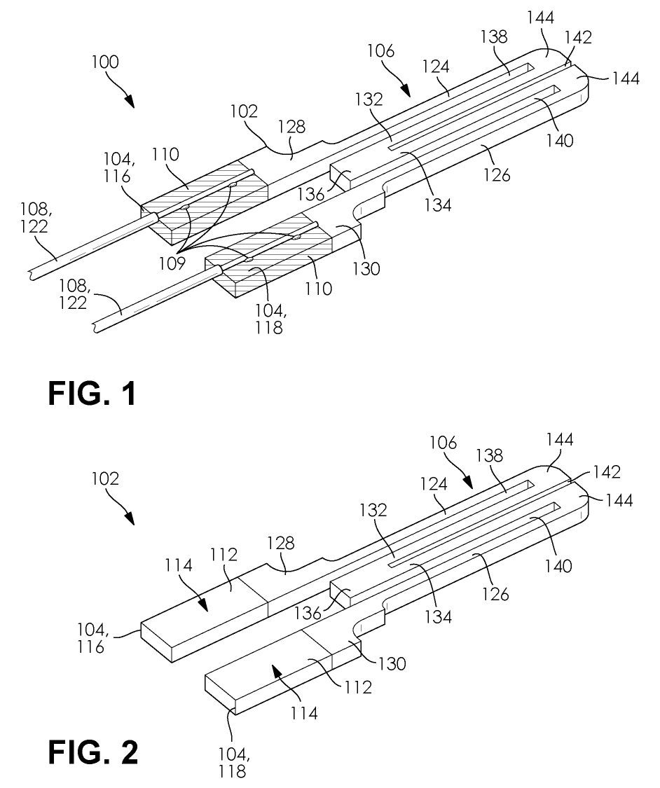

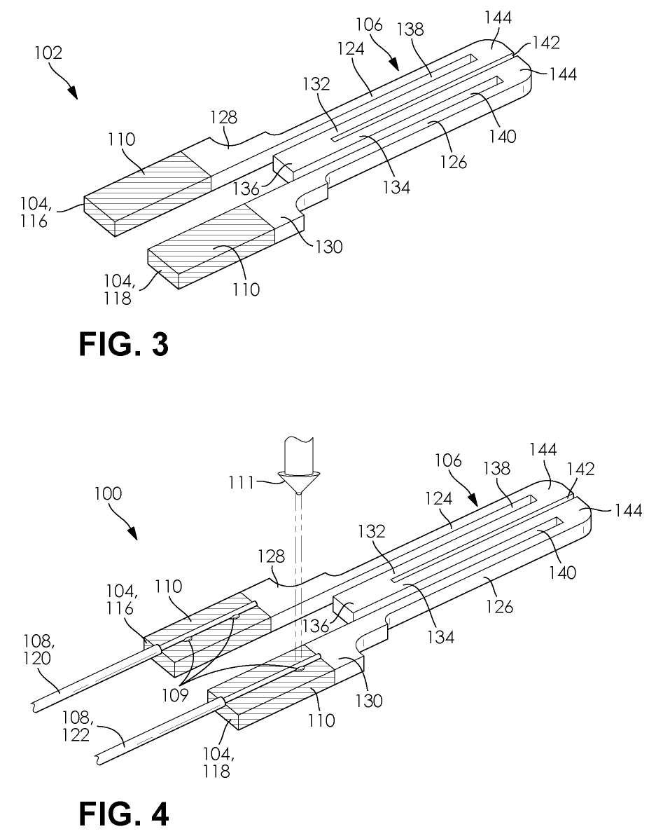

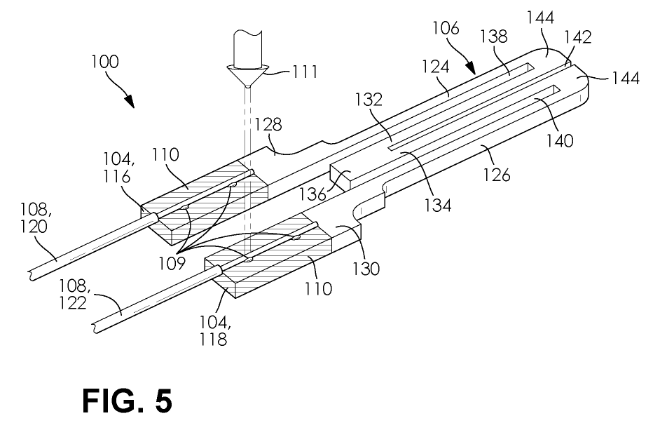

Referring now to FIGS. 1-5, in certain embodiments, a ceramic resistance igniter 100 is provided. The ceramic resistance igniter 100 can include a ceramic body 102. The ceramic body 102 can include a terminal 104 and a resistive element 106. A wire 108 can be coupled to the ceramic body 102 to form an electrical connection therewith. The ceramic resistance igniter 100 can be adapted for use in gas and liquid fuel burning systems, including a kitchen range, a furnace, a clothes dryer, a water heater, a pool heater, and other industrial, commercial, and residential appliances.

The ceramic body 102 can include a material that provides desired thermal, mechanical, and electrical properties. The terminal 104 and the resistive element 106 can each include silicon carbide, silicon nitride, alumina, zirconia, and combinations thereof. Silicon carbide can provide high thermal conductivity, excellent oxidation resistance, and the ability to withstand extreme temperatures encountered in ignition applications. Silicon nitride can provide high mechanical strength and thermal shock resistance, making it particularly well-suited for applications where rapid temperature fluctuations occur. Alumina can provide good electrical insulation properties and can be used in combination with other ceramic materials. Zirconia can provide enhanced toughness and thermal shock resistance.

In certain embodiments, the ceramic body 102 can include a homogeneous composition. A homogeneous composition can be a uniform composition throughout the ceramic body 102 without distinct layers or material boundaries. The homogeneous composition can be formed by selecting one or more ceramic materials, processing (e.g., milling, mixing, blending), and sintering or ceramicizing the material(s) to form a monolithic structure. The homogeneous composition can provide consistent mechanical and electrical properties throughout the ceramic body 102. The absence of material interfaces can reduce the risk of delamination or cracking during thermal cycling.

In certain embodiments, the ceramic body 102 can include two or more layers of different compositions, with each layer arranged to provide specific functional properties in different regions of the ceramic body 102. For example, a dense inner layer can provide structural integrity while a porous outer layer can provide thermal insulation. The layers can be bonded together during a sintering process to form an integrated structure. The use of multiple layers can allow for optimization of properties such as thermal conductivity, electrical resistivity, and mechanical strength.

In certain embodiments, the ceramic body 102 can include a core of a first material and an outer layer of a second material, where the first material can be different from the second material. The core can provide the primary structural and electrical properties of the ceramic resistance igniter 100, while the outer layer can provide protection against oxidation or chemical attack. For example, the core can include a dense silicon carbide material for electrical conductivity, while the outer layer can include a reinforced material that can improve oxidation resistance and thermal stability. The outer layer can substantially surround or encase the core to provide comprehensive protection. The first material can be silicon carbide, silicon nitride, alumina, zirconia, or combinations thereof. Silicon carbide can be a particularly suitable core material due to its high electrical conductivity and thermal stability. Silicon nitride can provide high strength and toughness as a core material. Alumina can provide good electrical insulation and can be combined with conductive materials to achieve the desired electrical properties. Zirconia can provide enhanced fracture toughness and thermal shock resistance. The second material of the outer layer can be silicon carbide, silicon nitride, alumina, zirconia, or combinations thereof. The outer layer material can be selected to provide specific surface properties such as oxidation resistance, chemical inertness, or enhanced mechanical durability. The outer layer can be applied by various techniques such as coating, infiltration, or co-sintering with the core material. The thickness of the outer layer can range from a few microns to several millimeters depending on the desired level of protection.

The terminal 104 can be a portion of the ceramic body 102 that provides an interface for electrical connection. The terminal 104 can include a metallized coating 110 applied to a portion 112 of a surface 114 thereof. The metallized coating 110 can be applied to facilitate electrical connection with the wire 108. In certain embodiments, the terminal 104 can include a first terminal leg 116 and a second terminal leg 118. Each of the first terminal leg 116 and the second terminal leg 118 can extend from the resistive element 106. Each of the first terminal leg 116 and the second terminal leg 118 can include the metallized coating 110. The wire 108 can include a first wire 120 coupled to the metallized coating 110 of the first terminal leg 116 and a second wire 122 coupled to the metallized coating 110 of the second terminal leg 118. The first terminal leg 116 and the second terminal leg 118 can be spaced apart from each other to provide electrical isolation therebetween. The spacing between the first terminal leg 116 and the second terminal leg 118 can militate against electrical shorting and can maintain distinct electrical paths through the ceramic resistance igniter 100.

In certain embodiments, the first terminal leg 116 and the second terminal leg 118 can each include a substantially rectangular cross-section. The rectangular cross-section can provide a surface area for application of the metallized coating 110 and for coupling the wire 108 thereto. The rectangular cross-section can also provide mechanical stability and can resist deformation during thermal cycling. Alternative cross-sectional shapes such as circular, oval, or other polygonal shapes can also be employed.

In certain embodiments, the resistive element 106 can include a first hairpin leg 124 and a second hairpin leg 126. A first end 128 of the first hairpin leg 124 can extend from the first terminal leg 116. A first end 130 of the second hairpin leg 126 can extend from the second terminal leg 118. A second end 132 of the first hairpin leg 124 and a second end 134 of the second hairpin leg 126 can be coupled and can form a hairpin connection 136. The first hairpin leg 124 can include a slot 138 between the first end 128 and the second end 132. The second hairpin leg 126 can include a slot 140 between the first end 130 and the second end 134. A slot 142 can be formed between the second end 132 of the first hairpin leg 124 and the second end 134 of the second hairpin leg 126. The first hairpin leg 124 and the second hairpin leg 126 can each include a hairpin portion 144 that can have a larger cross-section than the respective cross-section of the first hairpin leg 124 and the second hairpin leg 126, which can cause the hairpin portions 144 to remain relatively cool during operation and can concentrate thermal energy generation in portions of the first hairpin leg 124 and the second hairpin leg 126 between the hairpin portions 144 and the first terminal leg 116 and the second terminal leg 118. The hairpin connection can create an elongated electrical path through the resistive element 106 through which electrical current can travel during operation. This configuration can expose a high percentage of the surface area of the resistive element 106 directly to the surrounding environment for efficient heat radiation.

The metallized coating 110 can include a material that provides electrical conductivity and facilitates coupling of the wire 108 thereto. The metallized coating 110 can include nickel, a nickel alloy, aluminum, an aluminum alloy, zinc, a zinc alloy, stainless steel, or combinations thereof. The selection of the material for the metallized coating 110 can depend on factors such as the operating temperature of the ceramic resistance igniter 100, the chemical environment, and the desired electrical and thermal properties. The metallized coating 110 can provide a conductive interface between the ceramic body 102 and the wire 108.

In certain embodiments, the metallized coating 110 can include Haynes® 95 alloy. Haynes® 95 alloy includes a nickel-aluminum alloy manufactured and marketed by Haynes International, Inc., headquartered in Kokomo, Indiana, that can provide excellent oxidation resistance and can be particularly suitable for high-temperature applications. The composition of Haynes® 95 alloy can include approximately 95% nickel and 5% aluminum. The use of Haynes® 95 alloy as the metallized coating 110 can provide a durable and reliable electrical connection that can withstand repeated thermal cycling. Haynes® 95 alloy can be applied by a thermal spray process and can form a strong bond with the ceramic body 102.

In certain embodiments, the metallized coating 110 can include Rene 41® alloy. Rene 41® alloy includes a nickel-based superalloy manufactured and marketed by General Electric Company, headquartered in Boston, Massachusetts, that can include significant amounts of chromium, cobalt, molybdenum, and tungsten. Rene 41® alloy can be designed for applications requiring strength and oxidation resistance at temperatures exceeding those tolerable by Haynes® 95 alloy. The use of Rene 41® alloy as the metallized coating 110 can be particularly suitable for high-temperature applications such as cooktop igniters operating at elevated temperatures. Rene 41® alloy can provide enhanced durability and can resist spalling and flaking under severe thermal conditions.

The metallized coating 110 can include a thickness that provides electrical conductivity and facilitates coupling of the wire 108 thereto. The thickness of the metallized coating 110 can be sufficient to support the formation of a strong laser weld or other coupling mechanism between the wire 108 and the terminal 104. The thickness can be controlled during the application process to achieve the desired properties. In certain embodiments, the metallized coating 110 can have a thickness from 0.3 millimeters to 0.6 millimeters. This thickness range can provide a balance between adequate electrical conductivity, mechanical strength, and resistance to spalling. The thickness can be measured using optical microscopy or other suitable techniques.

In certain embodiments, the metallized coating 110 can be applied by a process that can provide a uniform and adherent coating on the surface of the terminal 104. The metallized coating 110 can be applied by high-velocity oxygen fuel spraying, flame spraying, plasma spraying, cold spraying, twin-wire arc spraying, and combinations thereof. High-velocity oxygen fuel spraying can provide a dense coating with low porosity and high bond strength. Flame spraying can be a cost-effective method for applying metallic coatings to ceramic substrates. Plasma spraying can provide high deposition rates and can accommodate a wide range of coating materials. Cold spraying can minimize thermal input to the substrate and can be suitable for temperature-sensitive materials. Twin-wire arc spraying can provide a high deposition rate and can be economical for large-scale production.

The wire 108 can provide an electrical connection between an external power source and the terminal 104 of the ceramic resistance igniter 100. The wire 108 can be coupled to the metallized coating 110 of the terminal 104 to form an electrical connection therewith. The wire 108 can be formed from a conductive material that can withstand the thermal and mechanical stresses associated with the operation of the ceramic resistance igniter 100. The wire 108 can be sufficiently flexible to allow for routing and connection to external electrical components while maintaining electrical continuity.

The wire 108 can include a nickel-based material having at least 50 percent nickel by weight. A nickel-based material can provide good electrical conductivity, oxidation resistance, and thermal stability at the elevated temperatures encountered during operation of the ceramic resistance igniter 100. The nickel content can enhance the compatibility between the wire 108 and the metallized coating 110, particularly when the metallized coating 110 also includes nickel or nickel-based materials such as Haynes 95® alloy or Rene 41® alloy. Alternative materials such as nickel alloys, stainless steel, or other oxidation-resistant metals can also be employed.

The wire 108 can include a two or more strands. A wire including two or more strands can provide enhanced flexibility. The use of multiple strands can also provide redundancy in the electrical connection, such that if one strand fails, the remaining strands can continue to carry current. The strands can be tightly bundled with minimal gaps to ensure consistent electrical contact and to facilitate effective laser welding. In certain embodiments, the wire 108 can be an 18-gauge or 20-gauge stranded wire. An 18-gauge wire can provide a good balance between flexibility and current-carrying capacity for typical igniter applications. A 20-gauge wire can be suitable for applications requiring less current or where space constraints favor a smaller wire diameter. The selection of wire gauge can depend on the electrical current requirements of the ceramic resistance igniter 100 and the physical constraints of the installation environment.

The wire 108 can be coupled to the metallized coating 110 of the terminal 104 by a laser weld 109. A laser weld 109 can provide a metallurgical bond between the wire 108 and the metallized coating 110 that can offer superior electrical conductivity and mechanical strength compared to mechanical joining methods. The laser weld 109 can eliminate the need for an intermediate mechanical connector, thereby reducing the number of components and potential failure points in the electrical connection. The laser welding process can be controlled to minimize thermal input to the ceramic body 102, thereby reducing the risk of thermal shock or cracking.

In certain embodiments, the laser weld 109 can be formed by a laser 111 that can provide the necessary energy density and control to achieve fusion between the wire 108 and the metallized coating 110. The laser 111 can be a fiber laser, an Nd:YAG laser, a direct diode pumped laser, an end-pumped laser, or combinations thereof. A fiber laser can provide high beam quality, excellent energy efficiency, and precise control of the welding process. An Nd:YAG laser can provide versatility in wavelength and pulse characteristics and can be suitable for welding a variety of metal combinations. A direct diode pumped laser can provide energy efficiency and compact size. An end-pumped laser can provide high power output and can be suitable for applications requiring deep penetration welds.

In certain embodiments, the laser weld 109 can be formed using argon shielding gas. Argon can be used as an inert gas that can militate against oxidation of the metallized coating 110 and the wire 108 at the weld interface during the welding process. Without shielding gas, the high temperatures generated by the laser can cause oxidation of the nickel surfaces, which can compromise the electrical conductivity, mechanical strength, and integrity of the weld joint. Argon can be heavier than air and can effectively blanket the weld zone to exclude atmospheric oxygen. Alternative inert gases such as helium or combinations of argon and helium can also be employed to achieve similar protective effects.

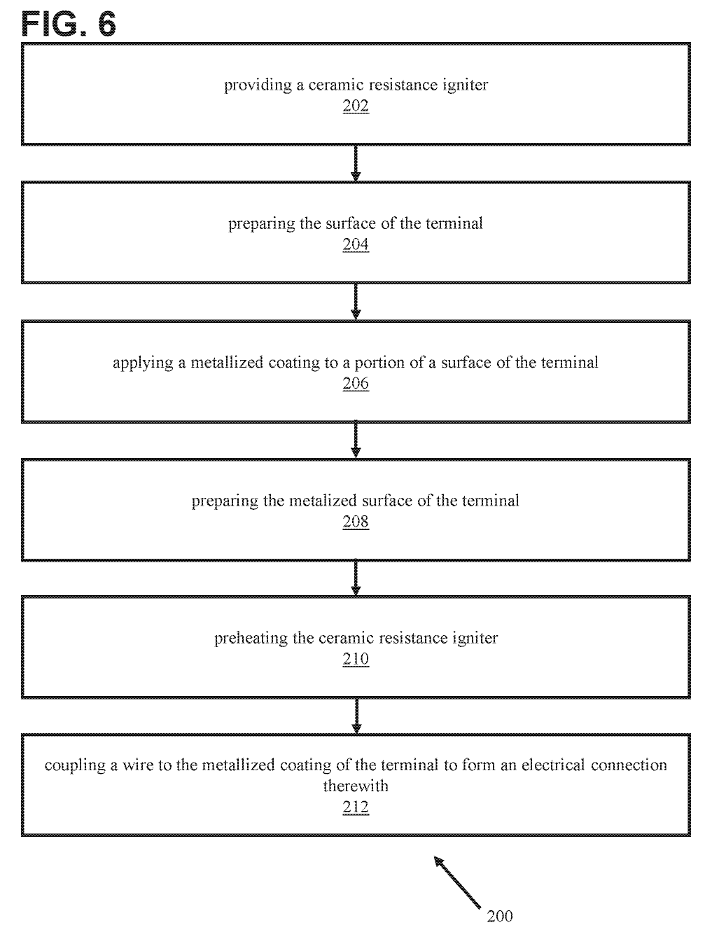

With reference to FIG. 6, in certain embodiments, a method 200 of manufacturing a ceramic resistance igniter 100 is provided. The method 200 can include a step 202 of providing a ceramic resistance igniter 100 as described herein. The method 200 can include a step 204 of preparing a surface 114 of a terminal 104. The method 200 can include a step 206 of applying a metallized coating 110 to a portion 112 of the surface 114 of the terminal 104. The method 200 can include a step 208 of preparing a metallized coating 110 of the terminal 104. The method 200 can include a step 210 of preheating the ceramic resistance igniter 100. The method 200 can include a step 212 of coupling a wire 108 to the metallized coating 110 of the terminal 104 to form an electrical connection therewith.

In certain embodiments, providing the ceramic resistance igniter 100 can include providing a green ceramic igniter and thermally processing the green ceramic igniter to form the ceramic resistance igniter 100. A green ceramic igniter can be an unfired ceramic body formed by slip casting, pressure casting, drip casting, pressing, extrusion, or other ceramic forming techniques known to a person having ordinary skill in the art. The green ceramic igniter can include silicon carbide powder, silicon nitride powder, alumina powder, zirconia powder, and combinations thereof mixed with a liquid carrier and optional binders or plasticizers. The green ceramic igniter can be shaped into an igniter configuration using a mold or die. Thermally processing the green ceramic igniter can include firing the green ceramic igniter at a predetermined temperature to sinter the green ceramic igniter and develop the desired mechanical and electrical properties for the ceramic resistance igniter 100.

Prior to applying the metallized coating 110, the surface of the terminal 104 can be prepared to improve adhesion of the metallized coating 110. The surface preparation can be performed by sandblasting, grit blasting, grinding, polishing, and combinations thereof. Sandblasting can include directing a stream of abrasive particles such as aluminum oxide or silicon carbide against the surface of the terminal 104 under compressed air pressure. The abrasive particles can remove surface contaminants and can roughen the surface to increase the surface area available for bonding. Grit blasting is similar to sandblasting but can use different abrasive materials or particle sizes to achieve the desired surface finish. Grinding can include removing material from the surface using a rotating abrasive wheel or disk to create a smooth and uniform surface. Polishing can include using progressively finer abrasive media to achieve a very smooth surface finish.

The metallized coating 110 can be applied to a portion 112 of the surface 114 of the terminal 104 by a thermal spray process. The metallized coating 110 can be applied by high-velocity oxygen fuel spraying, flame spraying, plasma spraying, cold spraying, twin-wire arc spraying, and combinations thereof. High-velocity oxygen fuel spraying can include combusting a mixture of oxygen and fuel gas to create a high-velocity flame that can melt and propel metallic particles toward the surface of the terminal 104. The high velocity can result in a dense coating with low porosity and high bond strength. Flame spraying can be a similar process but can operate at lower velocities and can be more cost-effective for certain applications. Plasma spraying can include using an electric arc to create a plasma jet that can melt the metallic particles and propel them toward the substrate. Cold spraying can include accelerating solid metallic particles to high velocities without melting them, which can minimize thermal input to the substrate. Twin-wire arc spraying can include feeding two metallic wires toward each other and creating an electric arc between them. The arc can melt the wire tips, and compressed air can atomize the molten metal and propel it toward the surface of the terminal 104. Twin-wire arc spraying can provide high deposition rates and can be economical for large-scale production. The metallized coating 110 can have a thickness from 0.3 millimeters to 0.6 millimeters after application. The thickness can be controlled by adjusting the spray parameters such as spray distance, traverse speed, and number of passes. Multiple passes can be used to build up the desired coating thickness while maintaining uniform coverage across the surface of the terminal 104.

After applying the metallized coating 110, the metallized surface of the terminal 104 can be prepared prior to coupling the wire 108. The metallized surface can be prepared by cleaning with acetone, cleaning with isopropyl alcohol, and combinations thereof. Cleaning can remove contaminants such as oils, dust, or oxidation products that could interfere with the coupling process. Acetone can be an organic solvent that can dissolve oils and greases and can evaporate quickly without leaving residue. Isopropyl alcohol can be another suitable solvent that can remove contaminants and can be compatible with the metallized coating 110 material. The cleaning can be performed by wiping the metallized surface with a cloth or applicator saturated with the solvent, or by immersing the terminal 104 in a solvent bath. The cleaned surface can be allowed to air dry or can be dried with compressed air or heat.

Prior to coupling the wire 108 to the metallized coating 110, the ceramic resistance igniter 100 can be preheated to a temperature from 150 degrees Celsius to 200 degrees Celsius. Preheating can reduce thermal shock and can minimize thermal gradients during coupling of the wire 108. Thermal shock can occur when a localized region of the ceramic body 102 experiences a rapid temperature change, which can create stresses that can lead to cracking or fracture. By preheating the ceramic resistance igniter 100, the temperature difference between the preheated body and the coupling process temperature can be reduced, thereby reducing the thermal shock. Preheating can also minimize thermal gradients across the ceramic body 102, which can reduce residual stresses that could compromise the integrity of the ceramic resistance igniter 100. Preheating can be performed in a furnace, on a hot plate, or using radiant heaters.

In certain embodiments, prior to coupling, the wire 108 can be bundled to minimize gaps between strands thereof. Bundling can include compressing or twisting the plurality of strands together to form a compact wire structure with minimal space between individual strands. Minimizing gaps can ensure that the wire 108 presents a continuous surface for coupling to the metallized coating 110 and can improve the electrical conductivity and mechanical strength of the connection. Bundling can be performed manually or using automated wire handling equipment. The bundled wire 108 can be held in the bundled configuration using clamps, fixtures, or other restraining devices during the coupling process.

In certain embodiments, prior to coupling, the wire 108 can be flattened to increase a contact area between the wire 108 and the metallized coating 110. Flattening can include compressing the wire 108 in a direction perpendicular to its longitudinal axis to create a wider, thinner cross-section. The increased contact area can provide a larger surface for coupling, which can improve the strength and electrical conductivity of the connection. Flattening can be performed using rollers, presses, or hammering tools. The degree of flattening can be controlled to achieve the desired contact area while maintaining sufficient thickness to avoid fracture or excessive deformation.

Coupling the wire 108 to the metallized coating 110 can include laser welding the wire 108 directly to the metallized coating 110. Laser welding can include directing a focused laser beam at the interface between the wire 108 and the metallized coating 110 to melt and fuse the materials together. The laser beam can provide localized heating that can create a metallurgical bond without significantly heating the surrounding ceramic body 102. Laser welding can eliminate the need for mechanical connectors, adhesives, or solder, thereby reducing the number of components and potential failure points in the electrical connection.

The laser used for laser welding can include a fiber laser, an Nd:YAG laser, a direct diode pumped laser, an end-pumped laser, and combinations thereof. A fiber laser can use an optical fiber doped with rare earth elements as the gain medium and can provide high beam quality and energy efficiency. An Nd:YAG laser can use a neodymium-doped yttrium aluminum garnet crystal as the gain medium and can provide a wavelength of approximately 1064 nanometers suitable for welding metallic materials. A direct diode pumped laser can use laser diodes to directly pump the gain medium, which can improve efficiency and reduce the size and complexity of the laser system. An end-pumped laser can have the pump light directed along the axis of the gain medium, which can provide uniform excitation and high beam quality.

Laser welding the wire 108 can include welding with or without a filler material. When welding with a filler material, the filler material can facilitate fusion between the wire 108 and the metallized coating 110 by providing additional material to fill gaps or irregularities at the interface. The filler material can include nickel, a nickel-based alloy, a nickel-chromium alloy, stainless steel, aluminum, zinc, and combinations thereof. The filler material can be selected to be compatible with both the wire 108 and the metallized coating 110 to ensure metallurgical bonding. The filler material can be supplied as a wire, powder, or paste and can be introduced into the weld zone during the laser welding process. When welding without a filler material, the laser can melt the wire 108 and the metallized coating 110 directly to create a fusion weld.

Laser welding the wire 108 can include using an inert shielding gas to militate against oxidation during the welding process. The inert shielding gas can be argon, helium, and combinations thereof. Argon can be heavier than air and can effectively displace oxygen from the weld zone to militate against oxidation of the hot metal surfaces. Helium can be lighter than air but can provide higher thermal conductivity, which can be beneficial for certain welding applications. A mixture of argon and helium can combine the advantages of both gases. The shielding gas can be delivered through a nozzle directed at the weld zone at a flow rate sufficient to maintain an inert atmosphere during welding.

Laser welding the wire 108 can include using a laser power from 50 watts to 150 watts and a focused beam spot size from 0.2 millimeters to 0.4 millimeters, thereby reducing thermal shock to the ceramic resistance igniter 100. The laser power can be selected to provide sufficient energy to melt the wire 108 and the metallized coating 110 without overheating the ceramic body 102. The focused beam spot size can determine the area over which the laser energy is concentrated. A smaller spot size can provide higher energy density for melting, while a larger spot size can distribute the energy over a wider area to reduce thermal gradients. The combination of laser power and spot size can be optimized to achieve strong welds while minimizing thermal shock.

Laser welding the wire 108 can include using a ramped pulse profile beginning at a first power and increasing to a second power, where the second power can be greater than the first power. A ramped pulse profile can gradually increase the laser power during each pulse rather than applying full power immediately. Beginning at a lower power can allow the materials to heat gradually, which can reduce thermal shock and can militate against cracking or spalling of the metallized coating 110. Increasing to a higher power can provide the energy needed to achieve complete melting and fusion. The ramped pulse profile can be controlled by the laser power supply to follow a predetermined power versus time curve.

Laser welding the wire 108 can include using a pulse duration from 5 milliseconds to 20 milliseconds, thereby minimizing a heat affected zone in the ceramic resistance igniter 100. The pulse duration can be the length of time that the laser is energized during each pulse. Shorter pulse durations can limit the amount of thermal energy transferred to the ceramic body 102, which can reduce the size of the heat affected zone and can minimize thermal damage. Longer pulse durations can provide more time for the materials to melt and fuse but can increase the risk of overheating. A pulse duration from 5 milliseconds to 20 milliseconds can provide a balance between achieving adequate fusion and minimizing thermal effects.

Laser welding the wire 108 can include applying a weld spot overlap from 40 percent to 60 percent to form a continuous seam, thereby improving strength of the laser weld and conductivity. Weld spot overlap can refer to the degree to which successive weld spots overlap along the length of the wire 108. An overlap of 40 percent to 60 percent can ensure that adjacent weld spots merge to form a continuous seam without gaps. A continuous seam can provide uniform electrical conductivity along the entire interface and can improve the mechanical strength of the connection by distributing loads over a larger area. Insufficient overlap can result in gaps between weld spots that can compromise electrical conductivity and mechanical strength, while excessive overlap can waste time and energy without providing additional benefit.

Laser welding the wire 108 can include forming two or more weld points on the wire 108. Forming two or more weld points can provide redundancy in the electrical and mechanical connection. If one weld point experiences degradation or failure, the second weld point can maintain the electrical connection. Two or more weld points can also distribute the electrical current and mechanical loads over multiple locations, which can reduce stress concentrations and can improve the overall reliability of the connection.

After coupling the wire 108 to the metallized coating 110, electrical conductivity across the connection can be verified. Verifying electrical conductivity can include performing a four-point probe test, resistance measurement, current flow test, voltage drop measurement, or combinations thereof. A four-point probe test can include applying a current through two outer probes and measuring the voltage between two inner probes to determine the resistance of the connection without being affected by contact resistance at the probes. The four-point probe test can be performed using an oscilloscope to visualize the voltage waveform and to ensure accurate measurements. A resistance measurement can involve using a digital multimeter or other resistance measuring device to determine the resistance of the connection. A current flow test can include applying a known current and verifying that the expected current flows through the connection based on Ohm’s law. A voltage drop measurement can involve measuring the voltage difference across the connection while a current is flowing to verify minimal resistance.

After coupling the wire 108 to the metallized coating 110, tensile testing can be performed on the connection. Tensile testing can involve applying a pulling force to the wire 108 in a direction away from the terminal 104 and measuring the force required to cause failure of the connection. The tensile test can verify that the connection has adequate mechanical strength to withstand the forces encountered during installation and operation of the ceramic resistance igniter 100. The tensile test can be performed using a tensile testing machine equipped with grips to hold the wire 108 and the igniter body. The test can be conducted according to an appropriate ASTM standard for testing welded joints.

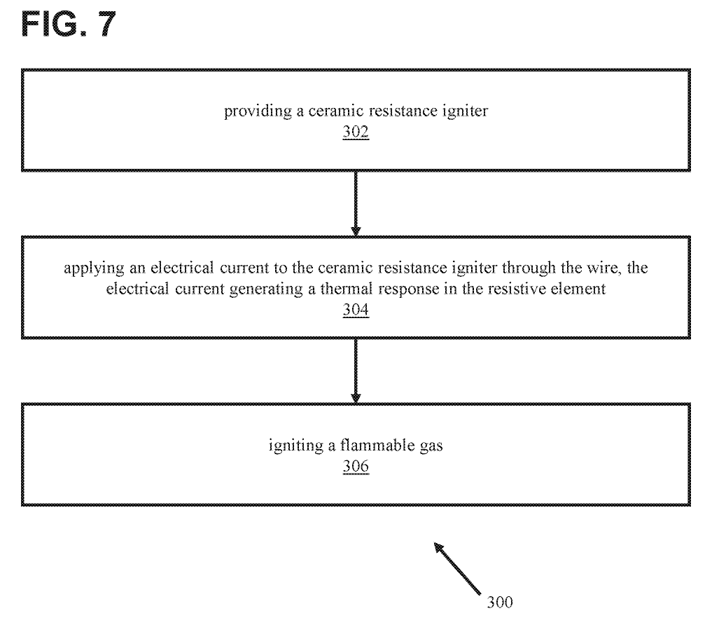

With reference to FIG. 7, in certain embodiments, a method 300 of operating a ceramic resistance igniter 100 is provided. The method 300 can include a step 302 of providing a ceramic resistance igniter 100 as described herein. The method 300 can include a step 304 of applying an electrical current to the ceramic resistance igniter 100 through a wire 108. The electrical current can generate a thermal response in a resistive element 106. The method 300 can include a step 306 of igniting a flammable gas. The method 300 can be performed in a residential, a commercial, or an industrial application where ignition of a flammable gas is required for heating, cooking, or other combustion processes.

Providing the ceramic resistance igniter 100 can include installing the ceramic resistance igniter 100 in an appliance or system where ignition of a flammable gas is required. The ceramic resistance igniter 100 can be positioned in proximity to a gas outlet or burner such that the resistive element 106 can be exposed to the flammable gas when the gas is released. The ceramic resistance igniter 100 can be mechanically secured using mounting brackets, clips, or other fastening mechanisms to maintain a stable position during operation.

Applying an electrical current to the ceramic resistance igniter 100 can include connecting the wire 108 to an electrical power source capable of providing the required voltage and current. The electrical power source can be an alternating current power source providing 120 volts or 240 volts, or a direct current power source providing a suitable voltage for the application. The electrical current can flow through the wire 108, through the metallized coating 110, and into the resistive element 106. The electrical current can encounter electrical resistance in the resistive element 106, which can cause conversion of electrical energy into thermal energy through resistive heating.

The thermal response in the resistive element 106 can include an increase in temperature of the resistive element 106. The resistive element 106 can heat rapidly from room temperature to a predetermined temperature sufficient to ignite the flammable gas. The resistive element 106 can emit thermal radiation that can be visible as a red or orange glow, indicating that the resistive element 106 has reached ignition temperature.

The method 300 can be repeated each time ignition of the flammable gas is required. The ceramic resistance igniter 100 can withstand hundreds of thousands of heating and cooling cycles during its operational life. The direct laser-welded connection between the wire 108 and the metallized coating 110 can provide a reliable and durable electrical connection that can maintain low electrical resistance and high mechanical strength throughout repeated thermal cycling. The elimination of mechanical connectors can reduce the likelihood of connection failure due to thermal expansion, vibration, or corrosion. The ceramic resistance igniter 100 can provide consistent ignition performance over its operational life with minimal degradation in response time or ignition reliability.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A ceramic resistance igniter, comprising:
a ceramic body including:
a terminal including a metallized coating applied to a portion of a surface thereof, and
a resistive element extending from the terminal, electrically coupled to the terminal, and configured to generate thermal energy when an electrical current is applied; and
a wire coupled to the metallized coating of the terminal to form an electrical connection therewith.

2. The ceramic resistance igniter of claim 1, wherein the terminal includes a first terminal leg and a second terminal leg, each of the first terminal leg and the second terminal leg extending from the resistive element, each of the first terminal leg and the second terminal leg including the metallized coating, and the wire includes a first wire coupled to the metallized coating of the first terminal leg and a second wire coupled to the metallized coating of the second terminal leg.

3. The ceramic resistance igniter of claim 1, wherein the metallized coating includes a material selected from a group consisting of nickel, a nickel alloy, aluminum, and aluminum alloy, zinc, a zinc alloy, stainless steel, and combinations thereof.

4. The ceramic resistance igniter of claim 1, wherein the metallized coating has a thickness from 0.3 millimeters to 0.6 millimeters.

5. The ceramic resistance igniter of claim 1, wherein the wire includes a nickel-based material having 50 percent nickel by weight.

6. The ceramic resistance igniter of claim 1, wherein the wire is coupled to the metallized coating of the terminal by a laser weld.

7. The ceramic resistance igniter of claim 6, wherein the laser weld is formed by a laser selected from a group consisting of a fiber laser, an Nd:YAG laser, a direct diode pumped laser, an end-pumped laser, and combinations thereof.

8. A ceramic resistance igniter, comprising:
a ceramic body including:
a terminal including a metallized coating applied to a portion of a surface thereof, and
a resistive element extending from the terminal, electrically coupled to the terminal, and configured to generate thermal energy when an electrical current is applied; and
a wire coupled to the metallized coating of the terminal to form an electrical connection therewith,
wherein:
the terminal includes a first terminal leg and a second terminal leg, each of the first terminal leg and the second terminal leg extending from the resistive element, each of the first terminal leg and the second terminal leg including the metallized coating, and the wire includes a first wire coupled to the metallized coating of the first terminal leg and a second wire coupled to the metallized coating of the second terminal leg,
the metallized coating has a thickness from 0.3 millimeters to 0.6 millimeters,
the wire includes a nickel-based material having 50 percent nickel by weight, and
the wire is coupled to the metallized coating of the terminal by a laser weld.

9. A method of manufacturing a ceramic resistance igniter, comprising:
providing a ceramic resistance igniter including:
a terminal and a resistive element extending from and electrically coupled to the terminal, the resistive element configured to generate thermal energy when an electrical current is applied;
applying a metallized coating to a portion of a surface of the terminal; and
coupling a wire to the metallized coating of the terminal to form an electrical connection therewith.

10. The method of claim 9, further comprising, prior to applying the metallized coating, preparing the surface of the terminal by a process selected from a group consisting of sandblasting, grit blasting, grinding, polishing, and combinations thereof.

11. The method of claim 9, further comprising, prior to coupling, preparing the metallized coating by a process selected from a group consisting of cleaning with acetone, cleaning with isopropyl alcohol, and combinations thereof.

12. The method of claim 9, further comprising, prior to coupling, preheating the ceramic resistance igniter to a temperature from 150 degrees Celsius to 200 degrees Celsius to reduce thermal shock and minimize thermal gradients during coupling.

13. The method of claim 9, wherein applying the metallized coating includes applying the metallized coating by a process selected from a group consisting of high-velocity oxygen fuel spraying, flame spraying, plasma spraying, cold spraying, twin-wire arc spraying, and combinations thereof.

14. The method of claim 9, wherein coupling the wire to the metallized coating includes laser welding the wire directly to the metallized coating.

15. The method of claim 14, wherein laser welding the wire includes using a laser selected from a group consisting of a fiber laser, an Nd:YAG laser, a direct diode pumped laser, an end-pumped laser, and combinations thereof.

16. The method of claim 14, wherein laser welding the wire includes using an inert shielding gas selected from a group consisting of argon, helium, and combinations thereof.

17. The method of claim 14, wherein laser welding the wire includes using a laser power from 50 watts to 150 watts and a focused beam spot size from 0.2 millimeters to 0.4 millimeters thereby reducing thermal shock to the ceramic resistance igniter.

18. The method of claim 14, wherein laser welding the wire includes using a pulse duration from 5 milliseconds to 20 milliseconds thereby minimizing a heat affected zone in the ceramic resistance igniter.

19. The method of claim 14, wherein laser welding the wire includes applying a weld spot overlap from 40 percent to 60 percent to form a continuous seam thereby improving strength of the laser weld and conductivity.

20. A method of operating a ceramic resistance igniter to ignite a flammable gas, comprising:
providing the ceramic resistance igniter of claim 1;
applying an electrical current to the ceramic resistance igniter through the wire, the electrical current generating a thermal response in the resistive element; and
igniting the flammable gas.
